(19) United States
(12) Patent Application Publication
(10) Pub. No.: US 2026/0300403 A1
(43) Pub. Date: Oct. 1, 2026

(54) FILTERING OUT SEGMENTS OF RECALLED DIGITAL ARTIFACTS BASED ON STRAINED CONTEMPORARY RELATIONSHIP STATUS

(71) Applicant: MOTOROLA MOBILITY LLC, WILMINGTON, DE (US)

(72) Inventors: AMIT KUMAR AGRAWAL, BANGALORE (IN); NAKUL PATEL, NAGPUR (IN); KRISHNAN RAGHAVAN, BANGALORE (IN)

(21) Appl. No.: 19/095,002

(22) Filed: Mar. 30, 2025

(51) Int. Cl. G06F 16/9035; G06F 16/908

(52) U.S. Cl. CPC G06F 16/9035; G06F 16/908

(57) ABSTRACT

A method automatically filters out entries from a digital artifact based on detection of strained relationship status. The method includes monitoring for indicators of a strained relationship with second persons, and, in response to a trigger to access/output a digital artifact, identifying whether a timeline entry included in the digital artifact is associated with, at least one of (i) the at least one second person with whom the user currently has a strained relationship or (ii) at least one specific activity associated with a second person with whom a strained relationship status is recorded contemporaneously with the specific activity. The method includes, in response to the digital artifact including at least one such timeline entry: removing the at least one timeline entry from the digital artifact; and presenting the digital artifact on the output device without the at least one timeline entry.

### RELATED APPLICATION

This application is related to commonly-invented and commonly-owned U.S. patent application Ser. No. 19/094,944, filed on even date herewith and entitled “Digital Memories and Feeds Based on Contemporary Relationship Status,” the disclosure of which is incorporated herein.

### BACKGROUND

### 1. Technical Field

The present disclosure generally relates to electronic devices that present visual content, and more specifically to electronic devices that present visual content corresponding to virtual/online associations.

### 2. Description of the Related Art

For many people, virtual relationships have become an extension of their physical lives. The average person interacts daily with friends, coworkers, potential clients, or potential love interests through digital platforms that support social or business relationships. In the best of times, virtual interactions with their contacts on such platforms leave the user of a given platform feeling uplifted, supported, or at least well connected. Conversely, at other times, the relationship with a contact may be strained, and the user may prefer to not have any interactions or reminders of the relationship, whether from these digital platforms or from content on the user's device. Reminders of these virtual relationships can surface as reminders/flashbacks at unscheduled times on a user device.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to implement preemptive monitoring and interactive management of potentially compromised digital relationships, according to one or more embodiments;

FIG. 1B is an additional block diagram representation of the electronic device of FIG. 1A presenting additional components, including components for wireless communications with other devices within a connected device ecosystem, according to one or more embodiments;

FIG. 2 depicts a dataflow diagram of the operation of a processor and associated artificial intelligence model of the electronic device in executing a selective digital content suppression (SDCS) module and/or a digital artifact content filtering (DACF) module, whereby the electronic device implements preemptive monitoring and interactive management of potentially compromised/strained digital relationships, according to one or more embodiments;

FIGS. 3A-3F depict example user interfaces during the implementation of preemptive monitoring and interactive management of potentially compromised digital relationships at the electronic device shown in FIGS. 1A-1B, according to several embodiments;

FIG. 4 depicts example user interfaces during a resolution following preemptive monitoring and interactive management of potentially compromised digital relationships at the electronic device shown in FIG. 1A-1B, according to one or more embodiments; and

FIGS. 5A-5B (collectively FIG. 5) depict a flowchart of a computer-implemented method for preemptive monitoring and interactive management of potentially compromised digital relationships, according to one or more embodiments.

FIGS. 6A-6B illustrates display screens of electronic device respectively presenting a digital artifact selection UI for accessing a selected journal artifact and a resulting journal artifact UI having a full complement of associated individual journal entries presented when no strained relationships are detected, according to one or more embodiments;

FIGS. 7A-7B present a pair of example journal artifact UIs illustrating an example of automated filtering of an original journal artifact with a full complement of the associated individual journal entries to generate and output a filtered journal artifact UI with a filtered list of individual journal entries following removal of a journal entry associated with an identified second person with whom a current relationship is strained, according to some embodiments;

FIGS. 8A-8B present another pair of example journal artifact UIs illustrating an example of automated filtering of a journal artifact that includes a specific entry associated with a second person with whom the user had a strained relationship contemporaneously with the activity recorded by/in the journal entry, according to some embodiments;

FIG. 9 is a flowchart of a computer-implemented method for monitoring strained relationships and dynamically removing, from a digital artifact, content specifically associated with a second person with whom the device user has a strained relationship, according to one or more embodiments;

FIG. 10 is a flowchart of a computer-implemented method for performing other features associated with the method of FIG. 9 to monitor a relationship status and update a repository based on said monitoring to enable removal of specific content from a digital artifact, based on detection and recording of a strained relationship, according to one or more embodiments; and

FIG. 11 is a flowchart of a computer-implemented method for removal of specific timeline entries from a timeline blog or journal presented as a digital artifact, based on detection of a strained relationship, according to one or more embodiments.

### DETAILED DESCRIPTION

According to aspects of the present disclosure, an electronic device, a method, and a computer program product enable preemptive management of virtual relationships on/with accounts of the user of an electronic device. According to a first aspect, upon detection of changes in the virtual relationship likely to indicate deterioration of the corresponding real-world relationship, the present disclosure prevents stored images or feeds involving the virtual contact from being surfaced to the user. According to a second aspect, in response to detected opening of a digital artifact that includes at least one timeline entry associated with a second person with whom a relationship is strained, the present disclosure filters out the at least one timeline entry and presents the digital artifact without the at least one timeline entry.

Virtual relationships now augment most aspects of our lives. Social media applications allow a user of an electronic communication device to keep in touch with family members that live far away. Messaging applications allows the user to send updates to friends when on the go. Dating applications allow the user to attract and arrange to meet potential mates from the comfort his or her home. So long as relationships with persons the user contacts through these virtual platforms are going well, virtual interactions are a pleasant tool that allows the user to reach out to friends and loved ones between physical visits or a way to be uplifted by viewing images or messages they have posted or that are surfaced automatically based on calendar events, such as anniversaries and birthdays. However, when real-life relationships with these persons sour, the user can feel a range of negative emotions when the words and/or likenesses of a now estranged in-person or virtual contacts surface on his or her virtual platforms.

In cases where the actual real-world relationship between the user and a virtual contact has soured, being exposed to archived photos or current digital activity associated with a virtual contact can leave a user disheartened, angry, sad, or otherwise disquieted. One first impulse of some may be to delete all saved digital media associated with the estranged contact(s), so as not to have to be reminded of the hurt or discomfort associated with seeing the contact. While this might bring the user temporary solace, the emotion-triggered deletion can lead to the permanent loss of treasured photos and quotes. Should the user ever reconcile with the estranged contacts, the user would regret losing his or her cherished memories. Manually suppressing saved photos and posts associated with these persons forces the user to confront his or her present grief as they select memories to be managed. Moreover, the user risks being exposed to fresh photos and feeds before they can take action, which only multiplies their unhappiness. In a different context, exposure to images of a deceased family member may be unsettling to the user as would exposure to images of a former spouse on the anniversary of the failed union. The first aspect of the present disclosure addresses the above issues by offering automated mitigation, and potential reconciliation, in such instances, based on monitoring of the digital behavior of both parties.

Additionally, digital artifacts, such as a timeline blog, are often created from multiple events/activities over a period of time. These multiple events may include at least one event involving or associated with a second person, with whom a current relationship may be strained. When a user recalls or accesses the digital artifact, all of the events are presented in their normal sequence, including the at least one event that can lead to the user having a negative (emotional or otherwise) response to having opened the digital artifact. This negative response can sour an otherwise pleasant experience that would arise from engaging with the digital artifact. A second aspect of the present disclosure addresses this specific use case of the multi-entry digital artifact by providing an automated filtering out of specific ones of the entries of the artifact based on a current relationship status (or an existing status at the time of the particular event) being strained.

According to one embodiment, an electronic device includes a display embedded in a user accessible surface of the electronic device, a communications subsystem that enables the electronic device to communicatively connect via a wireless connection to one or more networks and second electronic devices, a memory having stored thereon a selective digital content suppression (SDCS) module for automatically suppressing the surfacing of digital memories selectively based on autonomous tracking of change in relationship status. The electronic device has at least one processor communicatively coupled to the display, the communications subsystem, and the memory. The processor executes program code of the SDCS module, and is configured to cause the electronic device to monitor communication mediums accessible using the electronic device for indicators of relationship changes between a user of the electronic device and at least one other person with whom the user has an established relationship recorded in a repository that tracks user relationship status. The processor is further configured to cause the electronic device to predict via an artificial intelligence (AI) model whether a potentially negative emotional response is likely to occur when a visual memory including a specific person among the at least one other person is surfaced on the display. The processor is further configured to cause the electronic device to, in response to a prediction of the potentially negative emotional response to surfacing memories associated with the specific person, manage which visual memories are automatically presented on the display of the electronic device to exclude visual memories that include or are associated with the specific person.

Additionally, according to one aspect of the disclosure, a first method is disclosed for preemptive management of digital relationships for a user of an electronic device that is communicatively connected to one or more networks and second electronic devices. The method includes monitoring communication mediums accessible using an electronic device connection to one or more networks and second electronic devices for indicators of relationship changes between a user of the electronic device and at least one other person with whom the user has an established relationship recorded in a repository that tracks user relationship status. The method includes predicting via an artificial intelligence (AI) model whether a potentially negative emotional response is likely to occur when a visual memory including a specific person among the at least one other person is surfaced on the display. The method includes managing, in response to a prediction of the potentially negative emotional response to surfacing memories associated with the specific person, which visual memories are automatically presented on the display of the electronic device to exclude visual memories that include or are associated with the specific person.

According to another aspect of the disclosure, a second method is disclosed for filtering out and removing individual entries and/or segments of content from a multiple entry digital artifact, based on detection of a strained relationship with a second person with whom the particular entry/segment within the digital artifact is associated. The method includes monitoring, within user inputs received at an electronic device and communication exchanges and communication patterns with one or more external sources, for indicators of a strained relationship between a user of the electronic device and at least one second person with whom the user has an association. The method includes, in response to a trigger to retrieve and output a digital artifact via an output device of the electronic device: identifying whether the digital artifact comprises at least one timeline entry that invokes thoughts of, or is associated with, at least one of (i) the at least one second person with whom the user currently has a strained relationship or (ii) at least one specific activity that is associated with the at least one second person with whom a strained relationship status is recorded contemporaneously with the activity and which is determined to presents an ongoing negative user association within the digital artifact. The method includes, in response to the digital artifact comprising the at least one timeline entry: removing the at least one timeline entry from the digital artifact; and presenting the digital artifact on the output device without the at least one timeline entry.

Also disclosed is a computer program product comprising a non-transitory computer readable medium having computer program product instructions, that when executed by a processor of an electronic device communicatively connected via a wireless connection to one or more networks and second electronic device, configure the electronic device to perform a corresponding one of the above-presented method features and other method functions.

The above description contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with ordinary skill in the art upon examination of the figures and the remaining detailed written description. The above as well as additional objectives, features, and advantages of the present innovation will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, the code configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those of ordinary skill in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present innovation is defined by at least the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present innovation. Instances of such phrases in various places within the specification do not necessarily all refer to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. does not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest reasonable interpretation given the context in which that term is utilized. Within the description, the counterpart to the user, i.e., the person whose virtual images or posts are being suppressed, is referred to hereafter as the target party.

Those of ordinary skill in the art will appreciate that the hardware components and basic configuration depicted in the following figures may vary. The illustrative components are not intended to be exhaustive but rather are representative to highlight essential components that can be utilized to implement aspects of the described embodiments. For example, other devices/components may be used in addition to, or in place of, the hardware and/or firmware depicted. The depicted examples are not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, or otherwise) on the described embodiments.

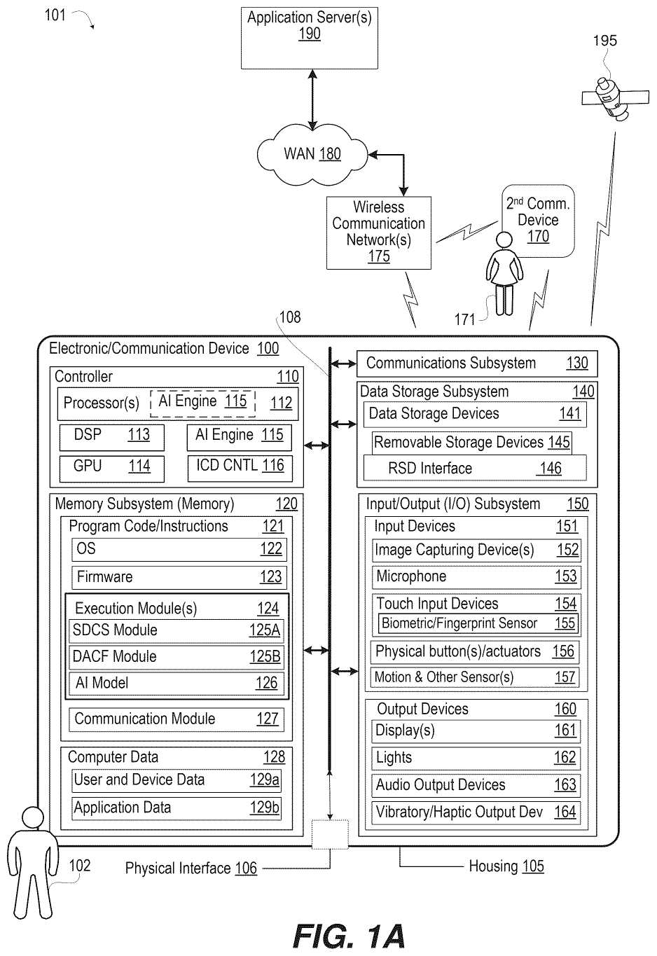

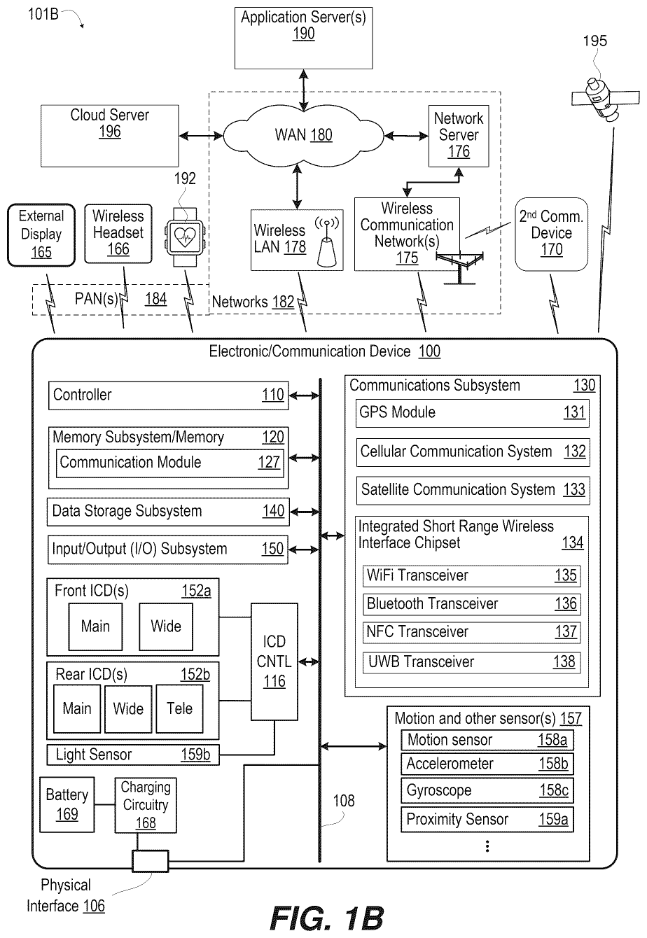

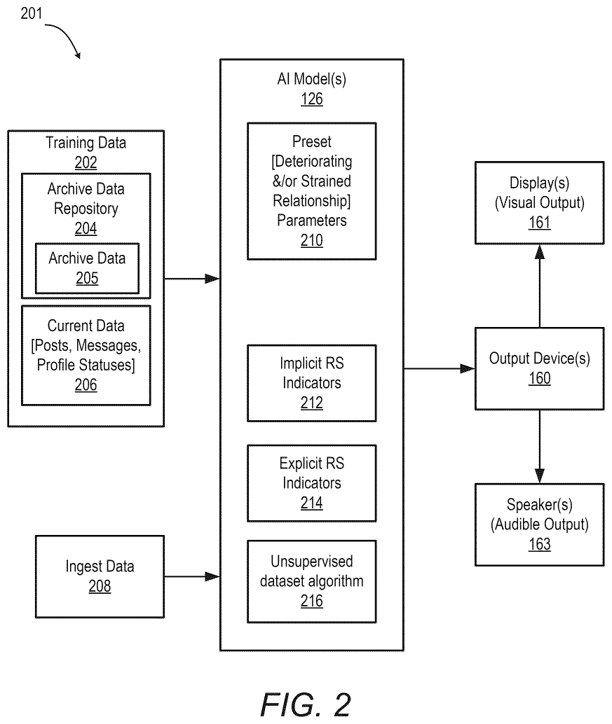

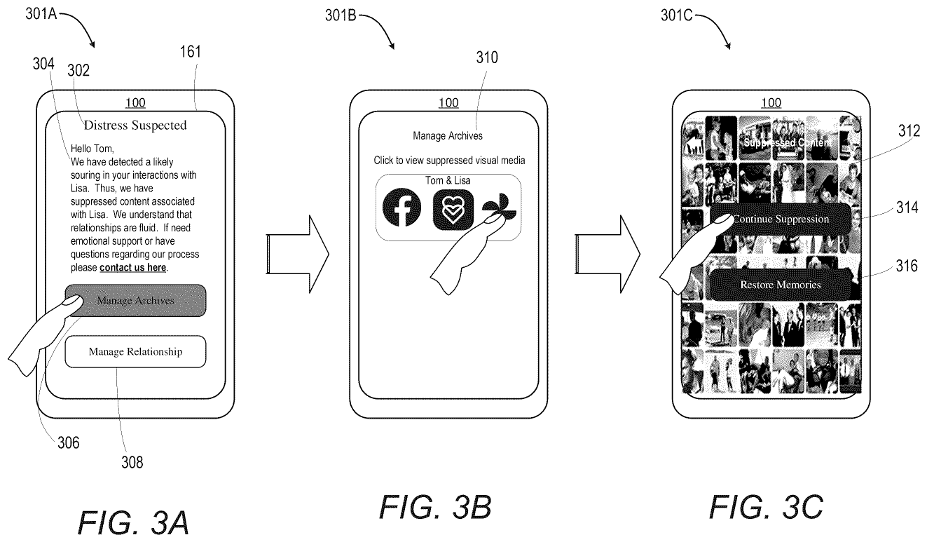

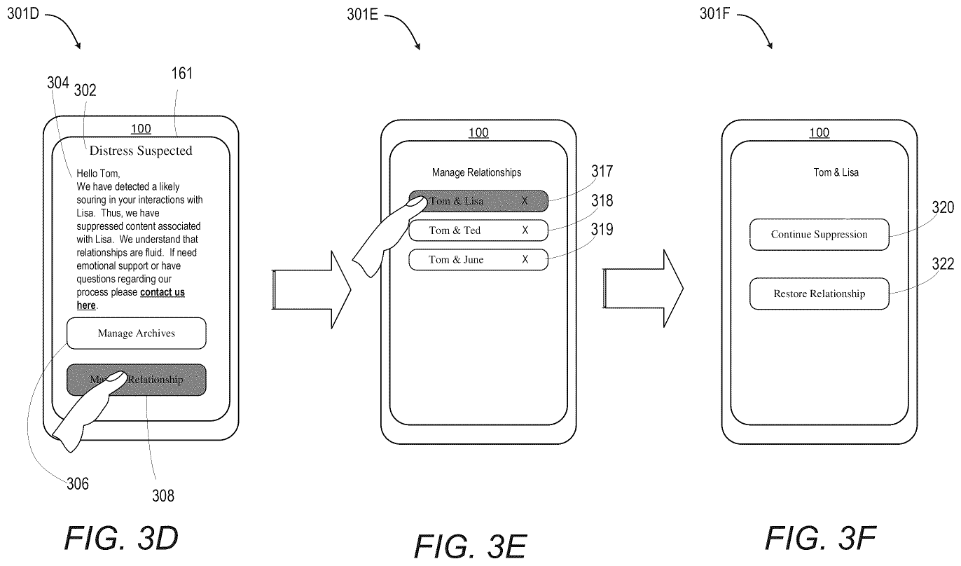

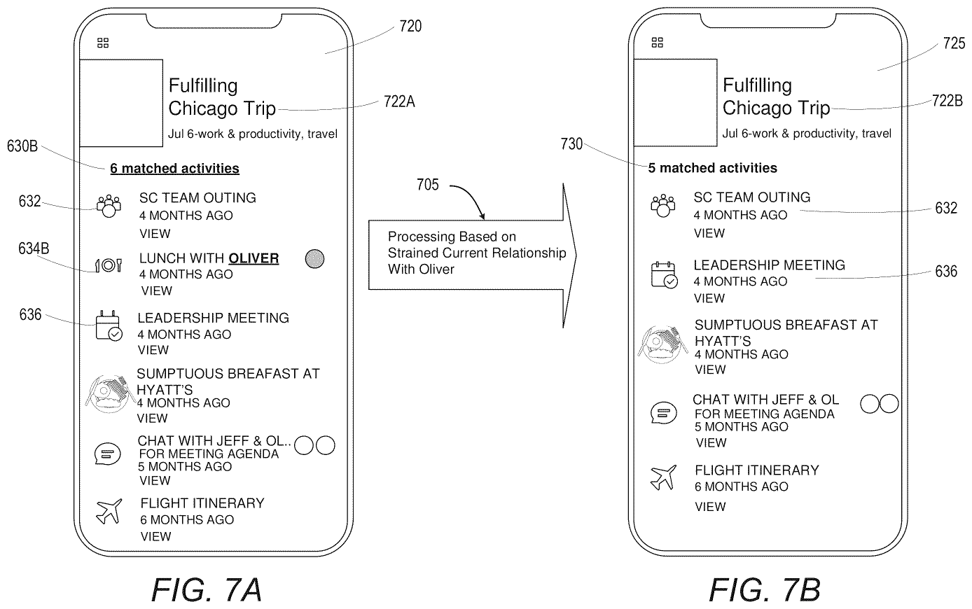

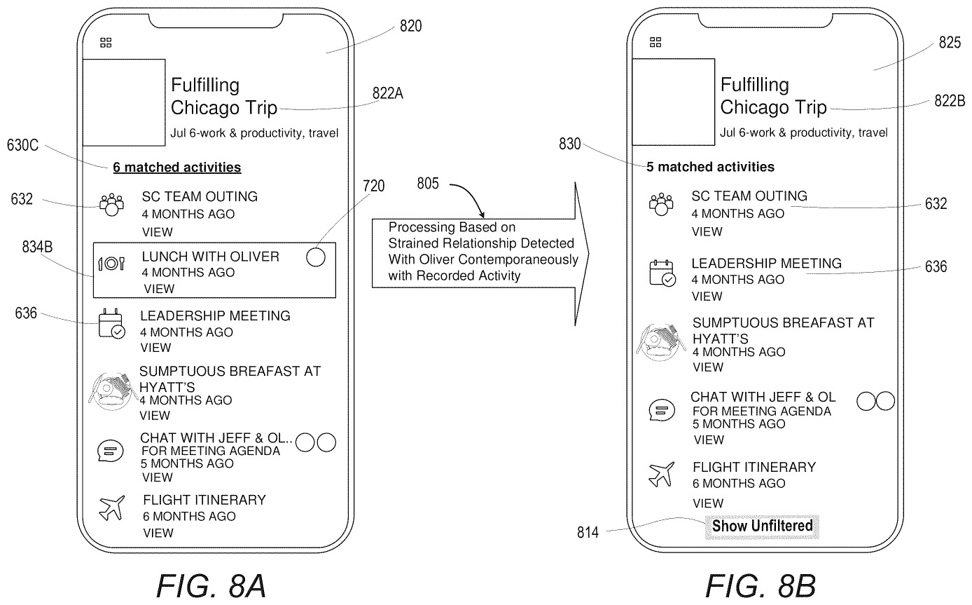

Referring now to the figures and beginning with FIG. 1A, there is illustrated a block diagram of an example electronic device 100 in a communication environment 101 and having hardware and software components, which enable the features of the present disclosure to implement preemptive monitoring and interactive management of potentially compromised digital relationships, according to one or more embodiments. Examples of electronic device 100 can include, but are not limited to, mobile devices, a notebook computer, a mobile phone, a smart phone, a digital camera with enhanced processing capabilities, a smart watch, a tablet computer, and other types of electronic devices. In the described embodiments, reference is made to a first electronic device and a second electronic device. For purposes of the description of the various embodiments herein, FIG. 1 (FIG. 1A and FIG. 1B) is presented as/from the perspective of the first electronic device, which is the device through which a user has access to accounts on virtual communication platforms that are subject to preemptive management of digital relationships, namely shielding the user from images deemed unsettling after a change in the nature of the relationship with a virtual contact. FIG. 2 depicts the process of determining whether or not there is a need for preemptive management of digital relationships based on digital behavior of the user and an estranged virtual contact. FIGS. 3A-3F depict a series/sequence of interactive interfaces presented to the user when preemptive management of digital relationships is deemed necessary. FIGS. 7A-7B, and 8A-8B depict pairs of user interfaces presenting digital artifacts having multiple individual entries, with at least one timeline entries identified for filtering out and subsequently removed from the outputted digital artifact.

Referring to FIG. 1A, electronic device 100 generally includes controller 110, memory (or memory subsystem) 120, communications subsystem 130, data storage subsystem 140, and input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more operational components within controller 110, including those provided by processor 112 are collectively described as being performed by controller 110. Collectively, components integrated within controller 110 support computing, classifying, processing, transmitting, and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores program code/instructions 121 for execution by processor 112 to configure processor 112 (and more generally electronic device 100) to provide the operational functions and features described herein. Program code/instructions 121 (or program code 121 for short) includes instructions for an operating system (OS) 122, and firmware 123, such as basic input/output system (BIOS) or Uniform Extensible Firmware Interface (UEFI). Program code 121 includes execution module(s) 124 that collectively provide the various features of the disclosure. Execution module(s) 124 include, without limitation, selective digital content suppression (SDCS) module 125A and digital artifact content filtering (DACF) module 125B, which respectively provide the features and operating functionality of the disclosed embodiments when the corresponding program instructions of SDCS module 125A and/or DACF module 125B are processed by/within processor 112/controller 110. Specifically, SDCS module 125A provides program instructions for anticipating, executing, and ceasing, at user accounts at relevant virtual communication platforms, the suppression of digital content including or associated with a target party. DACF module 125B provides program instructions for autonomously filtering out and removing, based on identified strained relationship status of an associated second person, at least one segment of content from a presented digital artifact comprising a plurality of distinct segments (e.g., a timeline blog with multiple timeline entries, including at least one entry having an association with, or triggering a recollection of, the second person). In some embodiments, DACF module 125B (or the features and functionality of DACF module 125B) are incorporated as a sub-routine or sub-module within the more general features and functionality of SDCS module 125A.

Execution module(s) 124 further include AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within SDCS module 125A and is trained to support the AI features of SDCS module 125A. Similarly, in one or more embodiments, AI model 126 is integrated as a sub-module within DACF module 125B and is trained to support the AI features of DACF module 125B. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data. The role of the AI model(s) 126 in executing the functionality of the SDCS module are further detailed in the description of FIG. 2.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules.

As a first example and according to one aspect of the disclosure, SDCS module 125A can include program instructions that cause or configure processor 112 to cause electronic device 100 to monitor communication mediums accessible using the electronic device 100 for indicators of relationship changes between a user 102 of the electronic device 100 and at least one other person with whom the user has an established relationship recorded in a repository used for tracking user relationship status. The controller 110 is further configured to cause the electronic device 100 to predict via an artificial intelligence (AI) model 126 whether a potentially negative emotional response is likely to occur when a visual memory including (or associated with) a specific person 171 among the at least one other person is surfaced on the display, the specific person being the user of a second communication device 170. The controller 110 is further configured to cause the electronic device 100 to, in response to a prediction of the potentially negative emotional response, manage which visual memories are automatically presented on the display of the electronic device to exclude visual memories that include or are associated with the specific person (i.e., the target party).

In one or more embodiments, the controller 110, is further configured to, in response to predicting the potentially negative emotional response is likely to occur, cause the electronic device 100 to generate and present a prompt to the user 102 of the electronic device 100 to confirm or deny a presence of current relationship distress associated with the specific person, the target party. The controller 110 is further configured to cause the electronic device 100 to, in response to the user 102 confirming the current relationship distress, suppress a digital connection to the specific person, and suppress archived visual media specific to the specific person to prevent surfacing of media content that conjures thoughts of the specific person. In a further embodiment, controller 110 is further configured to, in order to suppress the digital connection, cause the electronic device 100 to perform one or more operations from among a group of operations including: unfollow the specific person on social media platforms, unfollow select mutual contacts with the specific person on social media platforms, alter a status of the user 102 in relation to the specific person on lifestyle applications, and mask or remove digital content, notifications, and messages associated with the specific person.

In another embodiment, controller 110 is further configured to cause the electronic device 100 to create a separate hidden folder, and move archived visual media associated with the specific person to the separate hidden folder, in order to suppress archived data.

In another embodiment, controller 110, is further configured, in order to suppress a digital connection or suppress archived data, to cause the electronic device 100 to establish a future time for revisiting a status of an affected relationship with the specific person, and at the future time, output a prompt to the user regarding whether to re-engage communication and content sharing with the specific person.

In one or more embodiments, the controller 110 is further configured to cause the electronic device 100 to continue monitoring posts, messages, and profile statuses of the user and the specific person, at communication mediums accessible using the electronic device 100, for indicators of relationship changes between the user 102 and the specific person. The controller 110 is further configured to cause the electronic device 100 to store updated implicit relationship status indicators and updated explicit relationship status indicators identified during continued monitoring in the repository tracking user relationship status or in external storage accessible to the electronic device. The controller 110 is further configured to cause the electronic device 100 to train the AI model 126 to identify implicit relationship status indicators and explicit relationship status indicators within posts, messages, and profile statuses of the user and the specific person and information maintained on one or more online personal information and communication repositories.

The controller 110 is further configured to cause the electronic device 100 to assess via the AI model 126 whether a potentially negative emotional response is no longer likely to occur when a visual memory including or associated with a specific person among the at least one other person is surfaced on the display 161. The controller 110 is further configured to cause the electronic device 100 to prompt the user 102 to affirm or refute the assessment. The controller 110 is further configured to, in response to the user 102 affirming the assessment, cause the electronic device 100 to stop suppressing the digital connection and restore archived visual media associated with the specific person stored in the separate hidden folder. Implicit relationship status indicators may include AI model 126 observations related to transactional trends for a given person with whom the transactions were previously more or less frequent, including changes to social media statuses, updates to user profiles on lifestyle applications, and increased or decreased recent voice or message conversations as compared with a previous volume of such conversations. Explicit relationship status indicators comprise observations of overt actions associated with certain types of relationships, including blocking or unblocking a user and electronic messaging conversations explicitly indicating a change in relationship status. Other features provided by SDCS module 125A are described in further detail throughout this disclosure.

As another example, and according to a second aspect (or sub-aspect) of the disclosure, DACF module 125B can include program instructions that cause or configure processor 112 to cause electronic device 100 to autonomously filter out and remove, based on strained relationship status of an associated second person, at least one segment of content from a presented digital artifact comprising a plurality of distinct segments. The processor 112 executes program code of the DACF module 125B, and the processor 112 is configured to cause the electronic device 100 to monitor, within user inputs received at the electronic device and communication exchanges and communication patterns with one or more external sources, for indicators of a strained relationship between a user of the electronic device and at least one second person with whom the user has an association. The processor 112 is configured to cause the electronic device 100 to, in response to a trigger to retrieve and output a digital artifact via an output device among the at least one output device: identify whether the digital artifact comprises at least one timeline entry that invokes thoughts of, or is associated with, at least one of (i) the at least one second person with whom the user currently has a strained relationship or (ii) at least one specific activity that is associated with the at least one second person with whom a strained relationship status is recorded contemporaneously with the activity and which is determined to presents an ongoing negative user association within the digital artifact. The processor 112 is configured to cause the electronic device 100 to, in response to the digital artifact comprising the at least one timeline entry: remove the at least one timeline entry from the digital artifact; and present the digital artifact on the output device without the at least one timeline entry.

In one or more embodiments, to remove the at least one timeline entry, the processor 112 is further configured to cause the electronic device 100 to: crop the at least one timeline entry from the digital artifact; and stitch a following entry of the digital artifact to a preceding entry of the digital artifact to remove a gap created by cropping out of the at least one timeline entry.

In one or more embodiments, the processor 112 is configured to cause the electronic device 100 to save a filtered version of the digital artifact without the at least one timeline entry as a filtered digital artifact, in addition to an original unfiltered digital artifact.

In one or more embodiments, to monitor for the indicators of the strained relationship, the processor 112 is being further configured to trigger training of an artificial intelligence (AI) model with data models associated with normal relationship status and implicit and explicit indicators of strained relationship status, where the AI model performs the monitoring of the user inputs and analyzes content within the communication exchanges and contexts associated with detected patterns in communication by the user.

In one or more related embodiments, the processor 112 is configured to cause the electronic device 100 to: continue monitoring for indicators of relationship changes between the user and the at least one second person; and store, in a repository, updated implicit relationship status indicators and updated explicit relationship status indicators identified during monitoring. The processor 112 is configured to cause the electronic device 100 to assess via the AI model whether a current relationship status appears to no longer be strained, and generate and present on the output device a notification to prompt the user to affirm that the relationship is no longer strained. The processor 112 is further configured to cause the electronic device 100 to, in response to receiving user input indicating the relationship is no longer strained, present an unfiltered version of the digital artifact that comprises timeline entries associated with the at least one second person during subsequent generation and presentation of new digital artifacts.

In one or more embodiments, the processor 112 is configured to cause the electronic device 100 to: maintain a current relationship status with the at least one second person within a corresponding entry of a repository; and in response to the monitoring providing the indication of the strained relationship status with the at least one second person, automatically update the corresponding entry within the repository to include the strained relationship status in lieu of or in addition to a previous relationship status, the update comprising providing a timestamp recording a time of detecting the strained relationship status.

In one or more embodiments, the processor 112 is configured to cause the electronic device 100 to, prior to updating the repository: generate and present a prompt to the user of the electronic device to confirm or deny the strained relationship status associated with the at least one second person. The processor 112 is further configured to cause the electronic device 100 to, in response to receiving user confirmation of the strained relationship status: update the repository; and initiate monitoring for retrieval of pre-generated digital artifacts comprising timeline entries associated with or invoking memories of the at least one second person in order to one of (i) suppress the digital artifact altogether or (ii) filter out the timeline entries from the digital artifact prior to presenting the digital artifact on the output device.

In one or more embodiments, the processor 112 is configured to cause the electronic device 100 to establish a future time to revisit a relationship status with the at least one second person; and at the future time, generate and output a prompt for the user to indicate whether to remove the strained relationship status in the repository from the at least one second person.

According to one or more embodiments, the digital artifact comprises a timeline blog that includes a plurality of sequentially presented timeline entries, with at least one timeline entry having an associated context that is associated with one or more second persons. With these embodiments, the processor 112 is further configured to cause the electronic device 100 to: detect creation of the timeline blog as a new digital artifact comprising the at least one timeline entry associated with the at least one second person; identify a contemporaneous relationship status with the at least one second person at a time during an activity corresponding to the at least one timeline entry; and in response to the relationship status indicating a current strained relationship, tag the at least one timeline entry to indicate the strained relationship status.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 170 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which are received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of SDCS module 125A, DACF module 125B, and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detect the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile touch screen interface (154) can be utilized as an input device. The touch screen interface 154 can include one or more virtual buttons or selectable affordances. In one or more embodiments, when a user applies a finger or stylus on the touch screen interface 154 in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of housing 105. Other embodiments provide multiple integrated displays within electronic device 100 and references to display(s) 161 are assumed to refer to one or all of these multiple integrated displays.

Vibration device 164 can cause electronic device 100 to vibrate or shake when activated. Vibration device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101B. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101B that includes other devices.

Communications subsystem 130 includes a global positioning system (GPS) module 131 that enables electronic devices to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem 130 includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to utilize long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset, but can be separately provided hardware components. In one or more embodiments, electronic device 100 can communicate wirelessly with external wireless devices, such as a WiFi router of a wireless local area network (WLAN) 178 and/or second electronic device 170, via one or more short-range wireless interface(s). Second electronic device 170 can be a communication device, such as a smartphone, and/or can be similarly configured as electronic device 100. In one or more embodiments, electronic device 100 can receive Internet or Wi-Fi based calls, text messages, multimedia messages, and other notifications via a combination of wireless and wired networks (generally, networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can access applications, online transactions, and resources. In one or more embodiments, the WAN 180 can enable electronic device 100 to access a cloud server 196, which can receive and store data from electronic device 100 to be downloaded and used by second electronic device 170. In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as a data port and can be used as a power supply port that is coupled to charging circuitry 168 which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICD(s) can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image or iris scan recognition.

In the description of each of the following figures, reference is also made to specific components illustrated within the preceding figure(s). Similar or same components are presented with the same leading reference number.

FIG. 2 depicts a dataflow diagram of the operation of a processor and associated artificial intelligence (AI) model 126 of the electronic device 100 in executing SDCS module 125A and DACF module 125B, whereby the electronic device implements preemptive monitoring and interactive management of potentially compromised digital relationships and preemptive filtering of content segments, such as timeline entries, from multi-entry digital artifacts, according to multiple embodiments.

The processor 112 causes the AI model 126, in supporting the operation of the SDSC module 125A and DACF module 125B, to predict whether a potentially negative emotional response is likely to occur when a visual memory including, or having an association with, a specific person among the at least one other person (who is a virtual contact of the user 102) is surfaced on the display 161. To that end the AI model 126 takes in training data 202 and ingest data 208. Training data 202 may include archived data stored in a local repository/archive data repository 204 or current data 206 from virtual accounts of the user 102 or the target party such as currently visible posts, recently sent messages, or newly updated profile statuses. The AI model 126, in determining whether conditions suggest a potentially negative emotional response is a likely to result if the user 102 views digital content associated with the target party, may compare repository/archive data 205 and current data 206 to identify behavioral patterns indicative of a deteriorating relationship. Additionally, repository/archive data 205 and current data 206 may be compared to preset parameters 210 indicative of a deteriorating relationship. The prediction process may be further informed by ingest data 208 which can include data related to the user 102 or target party that differs from repository/archive data 205 and current data 206. In some example embodiments, ingest data 208 can include any number of unsupervised learning datasets (e.g., data that lacks annotation). Such data may be sourced, for example, from the feeds of the user or a target party and may comprise any observable features of a digital feed apart from designated training data 202. The unsupervised dataset algorithm 216 finds patterns and relationships in the unsupervised data. Analysis of unsupervised data may be directed toward detecting anomalies. An anomaly may be, for example, an opinion posted by a target party regarding the user 102 that is inconsistent with previously posted opinions or photos posted by a target party, especially when the target party has not posted a photo including the user for several months.

After the processor 112 predicts, via the AI model 126 data intake and evaluation processes, whether a potentially negative emotional response is likely to occur when a visual memory including (or associated with) a specific person among the at least one other person is surfaced on the display, the processor 112 continues monitoring posts, messages, and profile statuses of the user and the specific person (e.g., a person now tagged as an estranged virtual contact), at communication mediums accessible using the electronic device 100, for indicators of relationship changes between the user and the specific person. The processor 112 stores any updated implicit relationship status indicators and/or updated explicit relationship status indicators, found/identified during the continued monitoring, in the repository 204 that is used for tracking user relationship status, or in an external storage (not shown) that is accessible to the electronic device 100. The processor 112 further trains the AI model 126 to identify implicit relationship status indicators and explicit relationship status indicators within posts, messages, and profile statuses of the user 102 and the specific person and within information maintained on one or more online personal information and communication data repositories (archive data repository 204). Implicit relationship status indicators 212 include AI model 126 observations related to transactional trends for a given person with whom the transactions were previously more or less frequent, including changes to social media statuses, updates to user profiles on lifestyle applications, and increased or decreased recent voice or message conversations, as compared with a previous volume of such conversations. Explicit relationship status indicators 214 comprise observations of overt actions associated with certain types of relationships including blocking or unblocking a contact (e.g. the specific person) and electronic messaging conversations explicitly indicating a change in relationship status. Following an initial setting to block surfacing of visual memories for the specific person, the processor 112 further assesses, via the AI model 126, whether a potentially negative emotional response is no longer likely to occur when a visual memory including the target party is surfaced on the display 161 of the electronic device 100. The processor 112 can resume or reinitiate surfacing of the visual memories for the specific person in response to a later prediction/determination by the AI model 126 that the surfacing will no longer trigger the negative emotional response. In some embodiments, user confirmation of this resumption of surfacing of visual memories for the specific person can be requested via presentation of selectable options on a user interface, as described hereafter.

While described and presented as visual memories in the various embodiments, the disclosure contemplates also filtering out specific separate/individual segments or portions of content (e.g., individual entries) from among multiple entries of a digital artifact that is being audibly presented/outputted, such as by machine reading of text corresponding to the events or activities of the list of entries presented by the journal or blog.

FIGS. 3A-3F depict example sequences of user interfaces presented at electronic device 100 (FIGS. 1A-1B) during the implementation of preemptive monitoring and interactive management of potentially compromised digital relationships, according to several embodiments. Specifically, FIGS. 3A-3C depict a sequence of interfaces presented to the user 102 for managing stored digital images of or related to the target party while FIGS. 3D-3F depict a sequence of interfaces presented to the user for managing the ongoing digital relationship between the user 102 and the target party. FIGS. 3A-3C and 3D-3F present two alternate sequences of user interfaces on the display 161 of electronic device 100 after the processor 112 predicts, via the AI model 126, that a potentially negative emotional response is likely to occur when/if a visual memory including (or associated with) a specific person (who can be determined to be an estranged virtual contact in some embodiments) is surfaced on the display 161. In FIG. 3A first UI 301A includes UI header 302, which indicates relationship distress is suspected, and accompanying message 304 that informs the user 102, Tom, that suspected deterioration in the relationship between the user 102 and a virtual contact, Lisa, has been detected and that mitigation efforts have been implemented. First UI 301A also presents selectable options, including manage archives option 306 and manage relationship option 308. Accordingly, the user 102 is provided with the opportunity to manage archives related to which visual user memories (e.g., still images and videos) can be displayed relative to the identified virtual contact and which memories can be suppressed. Alternatively, the user 102 can manage the relationship with the identified virtual contact, Lisa, by selecting manage relationship option 308. In some embodiments, the user can ignore the selections, which effectively confirms the assessment and enables the processor to implement the suppression of content without explicit user selection or approval. As shown, the user 102 has opted to select manage archives option 306. As a result of that selection, the first UI 301A transitions to (i.e., is replaced on display 161 by) second UI 301B of FIG. 3B.

FIG. 3B includes second UI 301B in which the user 102 is presented view suspended content option 310, whereby the user 102 is given the opportunity to view/review the suppressed stored digital data associated with Lisa. As shown, the suppressed content includes a Facebook account (e.g., removing a following of Lisa's account), a dating app account, and archived visual media, such as digital photos/videos stored in a photo repository. Upon receiving user selection to view suppressed archived visual media, the processor presents the user 102 with third UI 301C of FIG. 3C.

FIG. 3C includes third UI 301C in which the suppressed archive data 312 is presented, and within which the user 102 is given the opportunity to choose between continuing to suppress the archived data (option 314) and restoring full access to the archived data (option 316). In some embodiments, the user 102 is also presented with a third option for restoring partial access to some user-selected archive data. In the presented example, the user 102 selects continue suppression option 314 and suppression of the digital connection is allowed to proceed. According to one or more embodiments, to suppress archived data, the processor 112 is configured to cause the electronic device 100 to complete actions including, but not limited to: create a separate hidden folder and/or move archived visual media associated with the specific person to the separate hidden folder.

FIG. 3D includes fourth UI 301D, which is similar to first UI 301A except for the user selection of manage relationship option 308. On detecting user selection of manage relationships option 308, the processor 112 configures the electronic device 100 to present fifth UI 301E of FIG. 3E.

FIG. 3E includes UI 301E, which presents the user with the opportunity to manage one of three relationships that are being tracked: first relationship with Lisa 317, second relationship with Ted 318, and third relationship with June 319. As shown, the user selects first relationship with Lisa 317 to manage based on the message 304 indicating that the relationship between the user and Lisa has likely soured. Following selection of first relationship with Lisa 317, the processor presents sixth UI 301F of FIG. 3F.

FIG. 3F includes UI 301F, which provides the user 102 (Tom) with the selectable options, including continue suppression option 320, which suppresses presentation of new still images and videos from or including Lisa, and restore full access option 322, which overrides the suppression and enables the processor to continue to surface/present images from or including Lisa. When suppression of the digital connection is allowed to proceed (based on user selection or user non-action at first UI 301A within a time-out period), the processor 112 is configured to cause the electronic device 100 to perform one or more operations from among a group of operations that include: unfollow the specific person on social media platforms; unfollow select mutual contacts with the specific person on social media platforms; alter a status of the user 102 in relation to the specific person (e.g., tagging as an estranged virtual contact) on lifestyle applications; mute the specific person on a messaging application; and mask or remove digital content, notifications, and messages associated with the specific person.

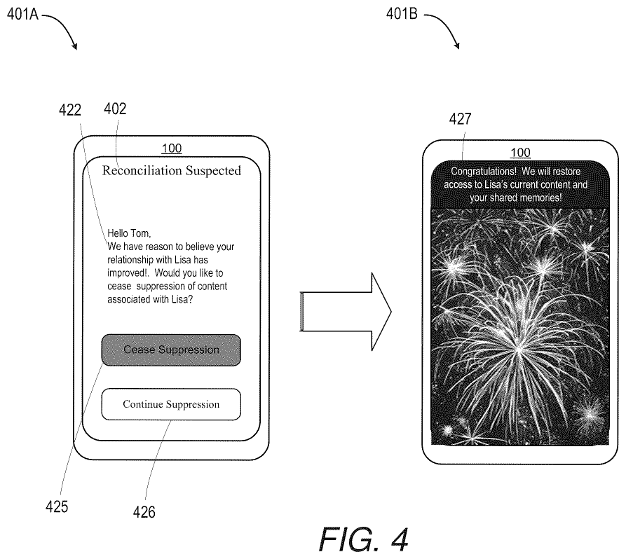

FIG. 4 presents a sequence of user interfaces presented following/during a removal of a previously suppressed surfacing of visual content for the specific person. Seventh UI 401A includes UI header 402, which indicates that the relationship distress has been mended, and accompanying message 422 that informs the user 102, Tom, that the relationship between the user 102 and virtual contact, Lisa, has been repaired. Seventh UI 401A also presents selectable options, including cease suppression option 425 and continue suppression option 426. Accordingly, the user is provided with the opportunity to end suppression of the digital connection between the user 102 and the target person and restore archived visual media associated with the target person. Such data may, for example, be stored in a separate hidden folder or in external storage accessible to the electronic device 100. Alternatively, the user 102 can elect continued suppression, which prompts the processor 112 to cause the electronic device 100 to continue preventing access to current feeds as well as archived still images and videos including or related to the target person. As shown, the user has elected cease suppression option 425. As a result of that selection, the seventh UI 401A transitions to (i.e., is replaced on display 161 by) eighth UI 401B in which the user 102 is presented with a confirmation message 427 which indicates that data will no longer be screened before being surfaced on display 161.

FIGS. 3A-3F and 4 illustrate features of an embodiment where the target party is a virtual contact of the user who has become estranged. However, in other embodiments, other target parties are contemplated. For example, the target party may be a deceased relative. In such a case, surfacing an image of the departed person on the electronic device 100 at display 161 may cause the user 102 to feel loneliness, longing, or even frustration over things left unsaid before the passing of their relative. Mitigation in this case may include implementing a temporary grace period of predetermined length (e.g., 6 months) during which digital media representing memories of or associated with the deceased person are not surfaced on the display 161 at the electronic device 100.

Alternatively, the target party may be a former spouse of the user. Notably, on the anniversary of the failed union, surfacing an image of the target party on the electronic device 100 at display 161 may cause the user 102 to feel emotions such as anger, resentment, regret, and longing. Mitigation in this instance may include preventing the surfacing of all visual media related to or including the former spouse, including videos and still images taken during the union, at display 161 on the anniversary date.

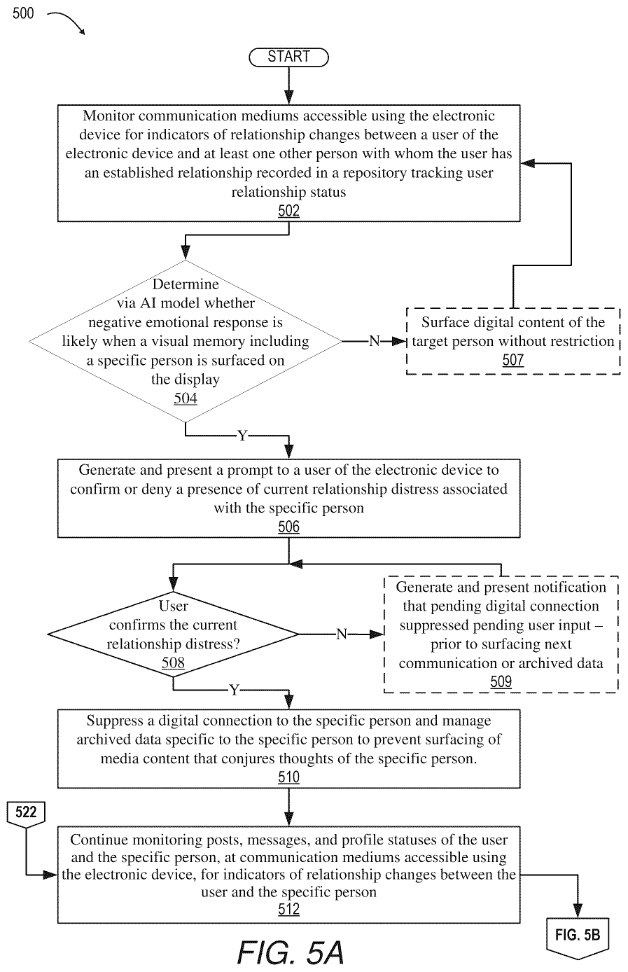

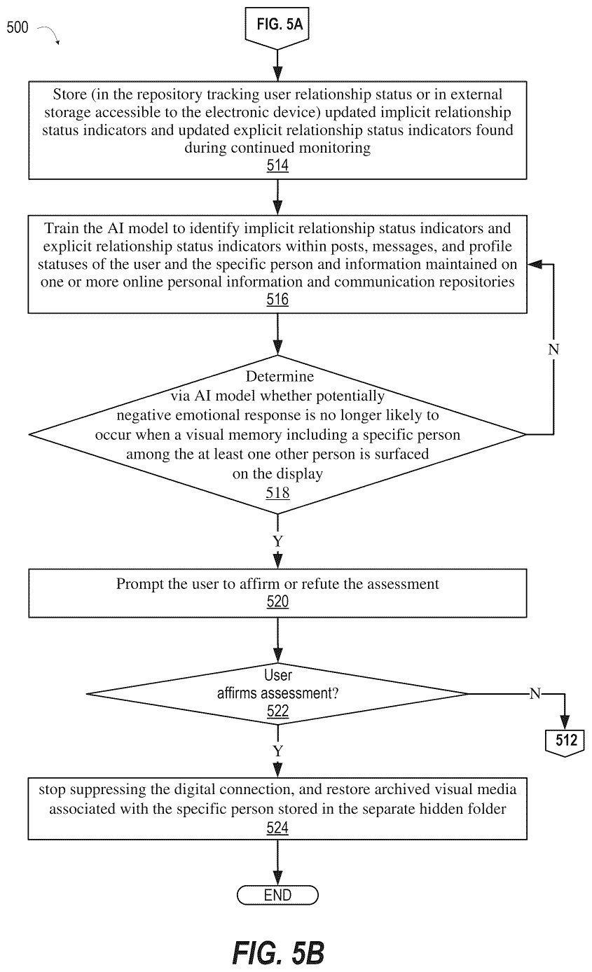

Referring now to the flowchart presented by FIGS. 5A-5B (collectively FIG. 5), the description of the method in FIGS. 5A-5B is provided with general reference to the specific components and features illustrated within the preceding FIGS. 1A-1B, FIG. 2, FIGS. 3A-3F, and FIG. 4. Specific components referenced in the methods of FIGS. 5A-5B may be identical or similar to components of the same name used in describing preceding FIGS. 1A-1B, FIG. 2, FIGS. 3A-3F, and FIG. 4. In one or more embodiments, processor 112 (FIG. 1A) is configured to provide the described functionality of the methods of FIGS. 5A-5B by executing program code for one or more modules or applications provided within device memory 120 of electronic device 100, including SDCS module 125A (FIG. 1).

FIGS. 5A-5B (collectively FIG. 5) depict a flowchart of a computer-implemented method for preemptive monitoring and interactive management of potentially compromised digital relationships, according to one or more embodiments. The method 500 starts at block 502 where the processor 112 of the electronic device 100 monitors communication mediums accessible using the electronic device 100 for indicators of relationship changes between a user 102 of the electronic device 100 and at least one other person (i.e., the target party) 107 with whom the user 102 has an established relationship recorded in a repository that tracks user relationship status. The method continues to block 504, where the processor 112 determines, via an artificial intelligence (AI) model 126, whether a potentially negative emotional response is likely to occur when a visual memory including or associated with a specific person among the at least one other person is surfaced on the display. If there is no potentially negative emotional response predicted to occur, the images/content associated with the target person are automatically surfaced at the device-selected times for surfacing (block 507), and the method returns to block 502. If a potentially negative emotional response is determined to be likely, the method proceeds to block 506, where the processor 112 generates and presents a user interface with a prompt to a user 102 of the electronic device 100 to confirm or deny a presence of current relationship distress associated with the specific person. The method proceeds to block 508, where a determination is made as to whether the user confirms the current relationship distress. If the user fails to confirm the current relationship distress, after a time-out period has elapsed, the method may optionally include conditionally suppressing the digital connection and retrieval of archived data and periodically prompt the user to first respond to a notification requesting confirmation or denial of the need to suppress the connection and the surfacing of archived data. As shown, method may optionally include generating and presenting a notification indicating that a pending message from or about a digital connection is being suppressed pending user input regarding whether to suppress or allow content from and/or associated with the target person (block 509). However, in an alternate embodiment, the method may include not suppressing the virtual connection or the retrieval of archived data unless user confirmation to suppress is expressly acquired. If the user confirms the current relationship distress, the method proceeds to block 510, where processor 112 suppresses a digital connection to the specific person and suppresses archived data specific to the specific person to prevent surfacing of media content that conjures thoughts of the specific person. A specific person 171 is alternatively designated a target person. Such persons may be virtual contacts of the user 102 of the electronic device 100 and communicate with the user 102 through communication mediums they access through second electronic device(s) 170. Alternatively, a specific person 171 or target person may be a person known to the user 102 deemed to be a person whose words or likeness, if surfaced on display 161 may be difficult for the user 102 to process. The method proceeds to block 512, where the processor 112 continues monitoring posts, messages, and profile statuses of the user 102 and the specific person, at communication mediums accessible using the electronic device 100, for indicators of relationship changes between the user 102 and the specific person. Then the method proceeds to FIG. 5B.

At FIG. 5B the method proceeds to block 514, where the processor 112 stores updated implicit relationship status indicators and updated explicit relationship status indicators identified during continued monitoring in the repository tracking user relationship status or in external storage accessible to the electronic device 100. The method proceeds to block 516, where the processor 112 trains the AI model 126 to identify implicit relationship status indicators and explicit relationship status indicators within posts, messages, and profile statuses of the user 102 and the specific person and information maintained on one or more online personal information and communication repositories. The method proceeds to block 518, where the processor 112 determines, via the AI model 126, whether a potentially negative emotional response is no longer likely to occur when a visual memory including or associated with a specific person among the at least one other person is surfaced on the display 161. If such a determination is not made, the method returns to block 516. If such a determination is made, the method proceeds to block 520, where the processor 112 presents another user interface that prompts the user 102 to affirm or refute that assessment. The method proceeds to block 522, where a determination is made as to whether the user 102 affirms the assessment. If the user does not affirm the assessment, the method returns to block 512. If the user 102 does affirm the assessment, the method proceeds to block 524, where the processor 112 stops suppressing the digital connection, and restores archived visual media associated with the specific person stored in the separate hidden folder. Then the method ends.

The above-presented descriptions describe the complete removal of a digital artifact such as a picture or social media posting related to a person with whom the relationship is strained or damage. According to one aspect of the disclosure, there are situations in which a wholescale removal of the entire digital artifact can be avoided and is preferred. Digital artifacts, such as journals and blogs, are often created to include multiple different entries, with the entries being separate individual components, some of which are associated with or linked to other persons. One aspect of the disclosure enables the filtering out of specific individual content segments, e.g., timeline entries of events/activities, from these multiple entry digital artifacts. The disclosure thus enables the autonomous filtering out of specific entries prior to generating and/or outputting the digital artifact, by removing those entries that are linked to or associated with a second person having a strained relationship status with the device user, rather than suppressing the entire digital artifact, as presented in the descriptions of FIGS. 3A-3B and 5A-5B. The disclosure presents two different implementations, each based on the timing of the strained relationship. In a first set of embodiments, presented by FIGS. 7A-7B, the strained relationship is a current strained relationship that is detected at the time the digital artifact is being recalled for presentation to the user. In another set of embodiments, presented by FIGS. 8A-8B, the strained relationship is detected contemporaneously to the occurrence of the events/activities that are recorded as a timeline entry. In these embodiments, the entry of itself can be specifically identified by the processor as being associated with a strained relationship that is determined by the electronic device based on contemporaneous communication and other activities being monitored and evaluated by the AI engine. In one or more embodiments, a tagging of the entry as being associated with a strained relationship can occur in the background, independent of the user's knowledge. The tagged entry is stored to the user's electronic device and is available for later access and inclusion in a journal artifact, such as in response to a user-triggered recall feature.

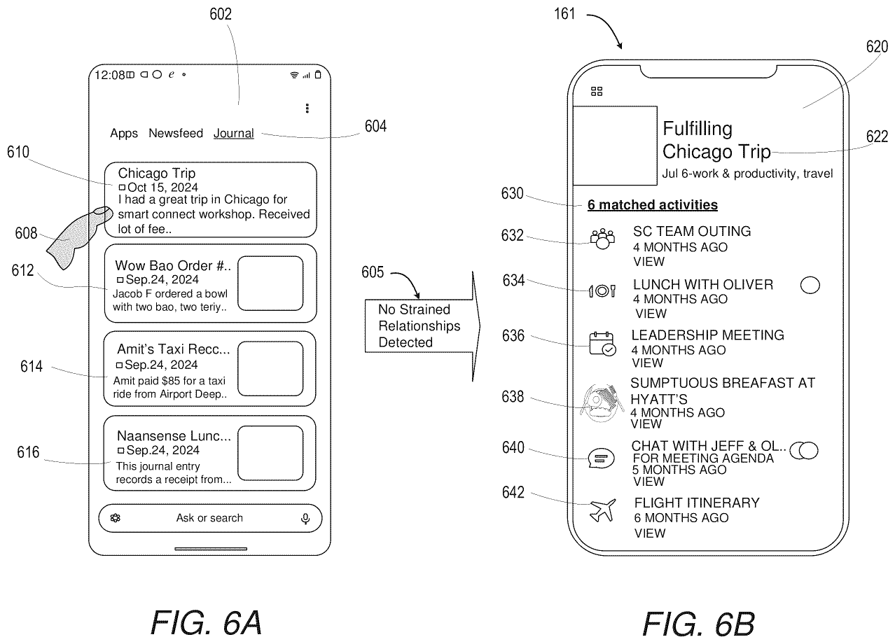

FIGS. 6A-6B illustrates display screens of electronic device 100 respectively presenting a digital artifact selection UI for accessing a selected journal artifact and a resulting journal artifact UI having a full complement of associated individual journal entries that would be presented when no strained relationships are detected, according to one or more embodiments. As shown in FIG. 6A, UI 602 presents multiple journals titles as separate digital artifacts (journal artifacts) 610-618 that are stored on and/or accessible from the device via user selection (e.g., via touch input 604) of a particular one of the presented journal artifacts 610-618. User has selected journal artifact 610 called “Chicago trip”. The selection triggers the retrieval of corresponding timeline entries and the output on display of second UI 620 presenting Chicago trip artifact 622. As indicated by the transition arrow 605, there are no strained relationships detected by the processor/AI engine, and thus, Chicago trip artifact 622 presents a full completement of 6 matched activities 630 that are associated with the Chicago trip, as presented as individual timeline entries 632-642, in reverse time sequence.

FIGS. 7A-7B present a pair of example journal artifact UIs illustrating one example of automated filtering of an original journal artifact with a full complement of the associated individual journal entries to generate and output a filtered journal artifact UI presenting a smaller list of individual journal entries following removal of a journal entry associated with an identified second person with whom a current relationship is strained, according to some embodiments. Referring first to FIG. 7A, there is illustrated an example journal artifact UI presenting an example complete (unfiltered) digital artifact that includes at least one identified entry that is associated with a second person with whom a current relationship with the user of the device is strained. Journal artifact UI 710 presents Chicago trip artifact 722A with the same complete list of six matched activities 630B shown as timeline sequenced list of entries describing activities and/or events associated with the Chicago business trip. However, lunch entry 634B describing lunch with Oliver held during the trip has been highlighted with a bolding of the font of Oliver's name and a corresponding relationship status circle filled in, which indicates that the device user's current relationship status with Oliver is strained/damaged. In one or more embodiments, once the relationship status is determined to be strained, the processor 112 completes a process of identifying the various digital artifacts and digital entries linked to or associated with the person (e.g., Oliver), and the processor 112 adds/appends a tag or metatag to the artifacts and/or entries to enable easier filtering out or suppression of those artifacts and/or entries during later processing. Notably, the relationship status circles of Jeff and Ol, with whom user has a Zoom call to set up the Chicago meeting agenda, are not filled in, to indicate the current relationship status is okay (i.e., not strained). The tagging of the second person with the strained relationship is indicated using the bold font and filling in of the relationship status circle, for illustration purposes only. It is appreciated that the processor-implemented electronic tagging process does not necessarily involve any modification of the visible content or use of other visual forms of relationship status markers.

Lunch entry 634B corresponding to lunch with Oliver during the Chicago trip is thus tagged. On detection of the trigger to open/access the Chicago trip journal artifact 610, (FIG. 6A), processor identifies that the entry 634B is linked with Oliver, with whom the user currently has a strained current relationship status, and processes the request to open the access the artifact (610) with filtering based on the strained current relationship, as indicated by the processing arrow 730. FIG. 7B presents the journal artifact UI 725 that is presented to the user following the filtering. As shown, a filtered version of the Chicago trip artifact 722B is presented with the list of entries excluding the lunch entry 634B, which has been removed by processor 112, based on the detected current strained relationship. A seamless presentation of the remaining entries is provided such that the user is able to review the other entries as a contiguous sequence of presented entries without being aware of the removal and/or filtering out of the lunch entry 634B so as not to remind the user of the potentially negative emotions tied to the current strained relationship.

FIGS. 8A-8B present another pair of example journal artifact UIs illustrating an example of automated filtering of a journal artifact that includes a specific entry associated with a second person with whom the user had a strained relationship contemporaneously with the activity recorded by/in an individual journal/timeline entry, according to some embodiments. Referring first to FIG. 8A, there is illustrated another example journal artifact UI 810 presenting the full complement of six matched activities 630C for the Chicago trip artifact 822A with one highlighted entry, lunch entry 834B that is associated with Oliver, with whom the user had a strained relationship contemporaneously with the timing of the lunch event. As utilized herein, the term contemporaneously can include a monitored time period before, during, and/or after the particular event, and the exact amount of time during which the relationship is strained can vary from the time around the event to a few days/weeks before and after the event, where the relationship status does not change from being strained within a processor-determined cooling-off period after the event (e.g., 2 weeks). As shown, lunch entry 834B includes an outline intended to represent that the entry is a tagged entry for possible processor filtering out during a later recall event. Request to present Chicago trip artifact 822A is received at a current time in which the user no longer has a strained relationship with Oliver. Accordingly, relationship status circle 820 for Oliver is not filled in, as opposed to circle 720 (FIG. 7A). On detection of the request/trigger to present Chicago trip artifact 822A, processor filters out (i.e., removes) lunch entry 834B based on the contemporaneously recorded strained relationship status around the time of the lunch, as indicted by process arrow 805. As shown by FIG. 8B, resulting filtered Chicago trip artifact 822B within user interface 825 provides the remaining 5 listed entries 830, without the lunch entry 834B in a contiguous sequence to avoid the user being visibly aware of the removal.

According to one embodiment, to generate the filtered digital artifact, by removing the at least one timeline entry, the device processor crops the at least one timeline entry from the digital artifact and then stitches a following entry of the digital artifact to a preceding entry of the digital artifact to remove a gap created by cropping out of the at least one timeline entry. The processor then saves the filtered version of the digital artifact without the at least one timeline entry as a filtered digital artifact. In one or more embodiments, the filtered digital artifact is saved in addition to an original unfiltered version of the digital artifact so that the original version can be retrieved at a later time if the relationship with the individual is no longer strained. In some embodiments, a selectable show unfiltered (artifact) option 814 can be provided for user selection to present the full complement of entries, including those removed during filtering. Selection of show unfiltered option 814 then causes the processor to render and output/present the example journal artifact UI of FIG. 8A.

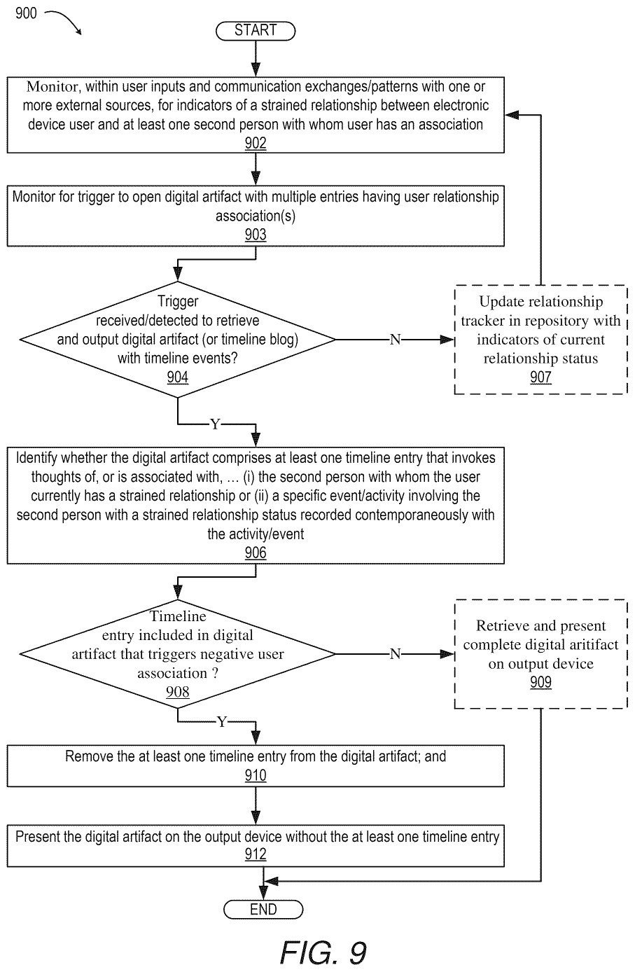

Referring now to the flowcharts presented by FIGS. 9, 10 and 11, the descriptions of the methods 900, 1000, 1100 presented by the flowcharts are provided with general reference to the specific components and features illustrated within the preceding figures. Specific components referenced in the methods of FIGS. 9, 10, and 11, may be identical or similar to components of the same name used in describing the preceding figures. In one or more embodiments, processor 112 (FIG. 1A) is configured to provide the described functionality of the methods 900, 1000, 1100 by executing program code for one or more modules or applications provided within device memory 120 of electronic device 100, including SDCS module 125A and DACF module 125B (FIG. 1).

FIG. 9 is a flowchart of a computer-implemented method for monitoring strained relationships and dynamically removing, from a digital artifact, content specifically associated with a second person with whom the device user has a strained relationship, according to one or more embodiments. Method 900 begins at start block and proceeds to block 902 at which method 900 includes monitoring, within user inputs received at the electronic device and communication exchanges and communication patterns with one or more external sources, for indicators of a strained relationship between a user of the electronic device and at least one second person with whom the user has an association. Method includes monitoring for detection of a trigger to retrieve and output a digital artifact that comprises a plurality of (i.e., multiple) individual timeline events (block 903) and determining at decision block 904 if the trigger is received to retrieve and output the multi-entry digital artifact. According to some embodiments, the detection of the input to open/output the artifact triggers a secondary analysis to determine whether the artifact does include multiple distinct entries that can be individually separated out. If the entries cannot be individually separated out, then the decisions on whether to present the artifact is processed according to method 500 of FIGS. 5A-5B, based on the relationship status of an identified second person who is associated with the artifact in some significant and/or user discernible way.

Returning to the flow chart, at block 907, when no trigger is received to retrieve the digital artifact, method includes updating the relationship tracker in a repository with indicators of current relationship status. The indicators are utilized by the AI engine to train the AI model and to update the current status based on the received indicators. In response to receiving a trigger to retrieve and output a multi-entry digital artifact via an output device of the electronic device: method 900 includes identifying whether the digital artifact comprises at least one timeline entry that invokes thoughts of, or is associated with, at least one of (i) the at least one second person with whom the user currently has a strained relationship (FIGS. 7A-7B) or (ii) at least one specific activity that is associated with the at least one second person with whom a strained relationship status is recorded contemporaneously with the activity and which is determined to presents an ongoing negative user association within the digital artifact (FIGS. 8A-8B) (block 906). Method 900 includes, in response to the digital artifact not including any timeline entries that are associated with a strained relationship whether contemporaneously with the event or currently (as determined at decision block 908), retrieving and presenting the complete digital artifact on the output device (block 909). Method 900 further includes, in response to the digital artifact comprising the at least one timeline entry (as determined at decision block 908), removing the at least one timeline entry from the digital artifact (block 910). Method 900 includes presenting the digital artifact on the output device without the at least one timeline entry (block 912). As indicated by FIG. 2, the digital artifact can be outputted as an image or an interactive user interface on the integrated display of the device or on an attached display. Alternatively and/or additionally, a text representation of the digital artifact can be outputted via a device speaker or connected audio output device as an audio recital/reading of the sequence of entries. Method 900 then ends.

In some embodiments, to implement the removing of the at least one timeline entry, method 900 includes cropping the at least one timeline entry from the digital artifact and stitching a following entry of the digital artifact to a preceding entry of the digital artifact to remove a gap created by cropping out of the at least one timeline entry, as presented by FIGS. 8A-8B. In some embodiments, method 900 further includes saving a filtered version of the digital artifact without the at least one timeline entry as a filtered digital artifact, in addition to an original unfiltered digital artifact.

In some embodiments, to implement the monitoring for the indicators of the strained relationship, method 900 includes training an artificial intelligence (AI) model with data models associated with normal relationship status and implicit and explicit indicators of strained relationship status. Following this training, the AI model performs the monitoring of the user inputs and analyzes content within the communication exchanges and contexts associated with detected patterns in communication by the user.

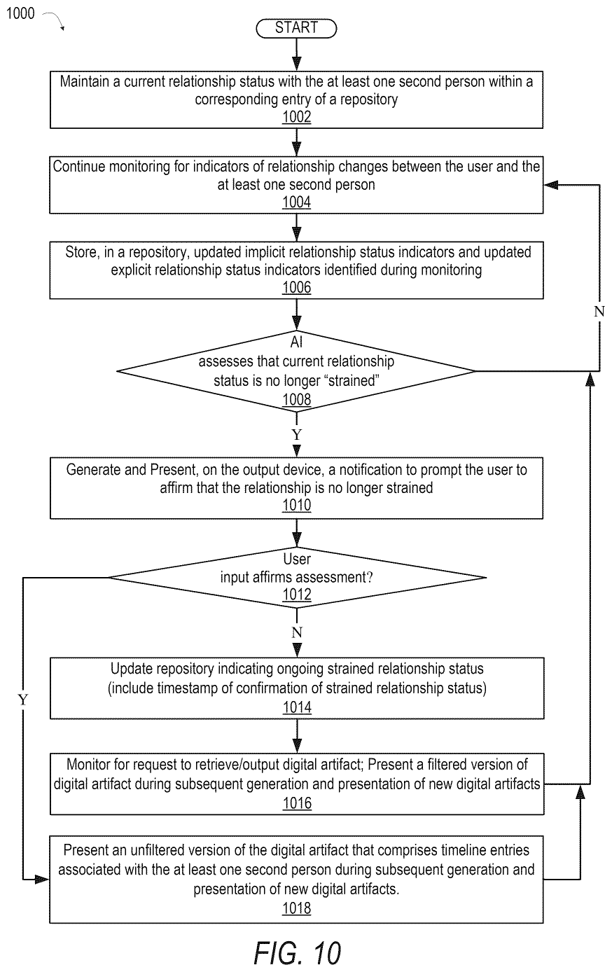

FIG. 10 is a flowchart of a computer-implemented method for performing other features associated with the method of FIG. 9 to monitor a relationship status and update a repository based on said monitoring to enable removal of specific content from a digital artifact, based on detection and recording of a strained relationship, according to one or more embodiments. Method 1000 begins at the start block and proceeds to block 1002 at which method 1000 includes maintaining a current relationship status with the at least one second person within a corresponding entry of a repository. In one or more embodiments, prior to updating the relationship status to indicate a strained relationship, method 1000 can include generating and presenting a prompt for the user to confirm or deny the strained relationship status associated with the at least one second person and performing the update to indicate the strained relationship status in response to receiving user confirmation of the strained relationship status. Method 1000 includes continuing monitoring for indicators of relationship changes between the user and the at least one second person (block 1004). Method 1000 includes storing, in the repository, updated implicit relationship status indicators and updated explicit relationship status indicators identified during monitoring (block 1006). The indicators are evaluated by the AI engine using AI models to determine updates or changes to the relationship status.

Method 1000 includes assessing via the AI model whether a current relationship status appears to no longer be strained (decision block 1008). Method 1000 includes, in response to detecting indicators that the current relationship is no longer strained, generating and presenting on the output device (i.e., display) a notification to prompt the user to affirm that the relationship is no longer strained (block 1010). Method 1000 includes determining, at decision block 1012, whether user input is received affirming the assessment that the relationship is no longer strained. Method 1000 includes, in response to not receiving user input confirming the relationship is no longer strained (i.e., not receiving any input or receiving input indicating the strained relationship status persists), updating the repository to indicate recent confirmation of the strained status, with a new timestamp of a current time of the update (block 1014). Additionally, method 1000 also includes continuing or initiating monitoring for retrieval of pre-generated digital artifacts comprising timeline entries associated with or invoking memories of the at least one second person in order to one of (i) suppress the digital artifact altogether or (ii) filter out the timeline entries from the digital artifact prior to presenting the digital artifact on the output device (block 1016).

From decision block 1012, in response to receiving user input indicating the relationship is no longer strained, method 1000 includes presenting an unfiltered version of the digital artifact that comprises timeline entries associated with the at least one second person during subsequent generation and presentation of new digital artifacts (block 1018). Method 1000 then returns to block 1004 to continue monitoring for indications of changes in the relationship status.

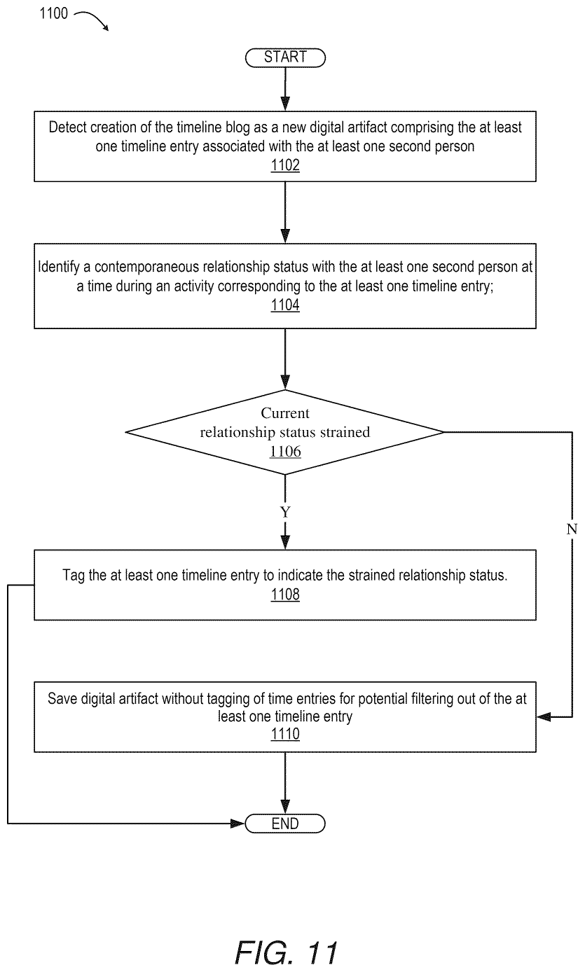

FIG. 11 is a flowchart of a computer-implemented method for removal of specific timeline entries from a timeline blog or journal presented as a digital artifact, based on detection of a strained relationship, according to one or more embodiments. In some embodiments, the digital artifact is or includes a timeline blog that includes a plurality of sequentially presented timeline entries, with at least one timeline entry having an associated context that is associated with one or more second persons. Method 1100 begins at start block and proceeds to block 1102 at which method includes detecting creation of the timeline blog as a new digital artifact comprising the at least one timeline entry associated with the at least one second person. Method 1100 includes identifying a contemporaneous relationship status with the at least one second person at a time during an activity corresponding to the at least one timeline entry (block 1104). Method 1100 includes determining whether the current relationship status is strained (decision block 1106). Method 1100 includes in response to the relationship status indicating a current strained relationship, tagging the at least one timeline entry to indicate the strained relationship status (block 1108). In response to the current relationship status not being strained, method 1100 includes saving the time entries as a part of the digital artifact without tagging of the time entry for potentially being filtering out (i.e., removed) when the digital artifact is later retrieved (block 1110). It is appreciated that the timing of the creation of the timeline blog may be after the event of the timeline entry, and that the tagging of the timeline entry would thus precede the inclusion of the timeline entry in the specific journal or timeline blog, in some embodiments.

Accordingly, by implementing the above-described processes, a user of an electronic device can preemptively prevent exposure of a user of virtual communication platforms and digital artifacts from encountering images and data feeds or timeline entries/events associated with a target party with whom a relationship is strained or damaged or otherwise negatively compromised. The methods disclosed herein require no effort or minimal effort from the user. The described methods thus represent an improvement over existing mitigation strategies which, being manual, would require the user to view status information, screen names, and other identifying information the user knows to be associated with a target party in evaluating the target party or events involving or associated with the target party for possible mitigation (e.g., suppression or filtering out). All such information may be upsetting to a user when a relationship with a target party has been compromised.

In the above-described methods, one or more of the method processes may be embodied in a computer readable device containing computer readable code such that operations are performed when the computer readable code is executed on a computing device. In some implementations, certain operations of the methods may be combined, performed simultaneously, performed in a different order, or omitted, without deviating from the scope of the disclosure. Further, additional operations may be performed, including operations described in other methods. Thus, while the method operations are described and illustrated in a particular sequence, use of a specific sequence of operations is not meant to imply any limitations on the disclosure. Changes may be made with regard to the sequence of operations without departing from the spirit or scope of the present innovation. Use of a particular sequence is therefore not to be taken in a limiting sense, and the scope of the present disclosure is defined primarily by the appended claims.

Aspects of the present innovation are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions.

Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present innovation may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and their practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the innovation has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include at least all embodiments falling within the scope of the appended claims.

What is claimed is:

1. An electronic device comprising:
at least one output device comprising at least one display;
a communications subsystem that enables the electronic device to communicatively connect to one or more networks and second electronic devices;
a memory having stored thereon a digital artifact content filtering (DACF) module for autonomously filtering out and removing, based on strained relationship status of an associated second person, at least one segment of content from a presented digital artifact comprising a plurality of distinct segments; and
at least one processor communicatively coupled to the at least one output device, the communications subsystem, and the memory, the at least one processor executing program code of the DACF module, and configured to cause the electronic device to:
monitor, within user inputs received at the electronic device and communication exchanges and communication patterns with one or more external sources, for indicators of a strained relationship between a user of the electronic device and at least one second person with whom the user has an association; and
in response to a trigger to retrieve and output a digital artifact via an output device among the at least one output device:
identify whether the digital artifact comprises at least one timeline entry that invokes thoughts of, or is associated with, at least one of (i) the at least one second person with whom the user currently has a strained relationship or (ii) at least one specific activity that is associated with the at least one second person with whom a strained relationship status is recorded contemporaneously with the specific activity and which is determined to presents an ongoing negative user association within the digital artifact; and
in response to the digital artifact comprising the at least one timeline entry:
remove the at least one timeline entry from the digital artifact; and
present the digital artifact on the output device without the at least one timeline entry.

2. The electronic device of claim 1, wherein to remove the at least one timeline entry, the at least one processor is further configured to cause the electronic device to:
crop the at least one timeline entry from the digital artifact; and
stitch a following entry of the digital artifact to a preceding entry of the digital artifact to remove a gap created by cropping out of the at least one timeline entry.

3. The electronic device of claim 1, wherein the at least one processor is further configured to cause the electronic device to:
save a filtered version of the digital artifact without the at least one timeline entry as a filtered digital artifact, in addition to an original unfiltered digital artifact.

4. The electronic device of claim 1, wherein to monitor for the indicators of the strained relationship, the at least one processor is being further configured to trigger training of an artificial intelligence (AI) model with data models associated with normal relationship status and implicit and explicit indicators of strained relationship status, wherein the AI model enables performance of the monitoring of the user inputs and analyzes content within the communication exchanges and contexts associated with detected patterns in communication by the user.

5. The electronic device of claim 4, wherein the at least one processor is further configured to cause the electronic device to:
continue monitoring for indicators of relationship changes between the user and the at least one second person;
store, in a repository, updated implicit relationship status indicators and updated explicit relationship status indicators identified during monitoring;
assess via the AI model whether a current relationship status appears to no longer be strained;
generate and present on the output device a notification to prompt the user to affirm that the relationship status is no longer strained; and
in response to receiving user input indicating the relationship status is no longer strained, present an unfiltered version of the digital artifact that comprises timeline entries associated with the at least one second person during subsequent generation and presentation of new digital artifacts.

6. The electronic device of claim 1, wherein the at least one processor is further configured to cause the electronic device to:
maintain a current relationship status with the at least one second person within a corresponding entry of a repository; and
in response to the monitoring providing indication of the strained relationship status with the at least one second person, automatically update the corresponding entry within the repository to include the strained relationship status in lieu of or in addition to a previous relationship status, the automatically update comprising providing a timestamp recording a time of detecting the strained relationship status.

7. The electronic device of claim 6, wherein the at least one processor is further configured to cause the electronic device to:
prior to updating the repository:
generate and present a prompt to the user of the electronic device to confirm or deny the strained relationship status associated with the at least one second person; and
in response to receiving user confirmation of the strained relationship status:
update the repository; and
initiate monitoring for retrieval of pre-generated digital artifacts comprising timeline entries associated with or invoking memories of the at least one second person in order to one of (i) suppress the digital artifact altogether or (ii) filter out the timeline entries from the digital artifact prior to presenting the digital artifact on the output device.

8. The electronic device of claim 6, wherein the at least one processor is further configured to cause the electronic device to:
establish a future time to revisit a relationship status with the at least one second person; and
at the future time, generate and output a prompt for the user to indicate whether to remove the strained relationship status in the repository from the at least one second person.

9. The electronic device of claim 1, wherein the digital artifact comprises a timeline blog that comprises a plurality of sequentially presented timeline entries, with at least one timeline entry having an associated context that is associated with one or more second persons.

10. The electronic device of claim 9, wherein the at least one processor is further configured to cause the electronic device to:
detect creation of the timeline blog as a new digital artifact comprising the at least one timeline entry associated with the at least one second person;
identify a contemporaneous relationship status with the at least one second person at a time during an activity corresponding to the at least one timeline entry; and
in response to the relationship status indicating a current strained relationship, tag the at least one timeline entry to indicate the strained relationship status.

11. A method comprising:
monitoring, within user inputs received at an electronic device and communication exchanges and communication patterns with one or more external sources, for indicators of a strained relationship between a user of the electronic device and at least one second person with whom the user has an association; and
in response to a trigger to retrieve and output a digital artifact via an output device of the electronic device:
identifying whether the digital artifact comprises at least one timeline entry that invokes thoughts of, or is associated with, at least one of (i) the at least one second person with whom the user currently has a strained relationship or (ii) at least one specific activity that is associated with the at least one second person with whom a strained relationship status is recorded contemporaneously with the specific activity and which is determined to presents an ongoing negative user association within the digital artifact; and in response to the digital artifact comprising the at least one timeline entry:
removing the at least one timeline entry from the digital artifact; and
presenting the digital artifact on the output device without the at least one timeline entry.

12. The method of claim 11, wherein:
removing the at least one timeline entry comprises:
cropping the at least one timeline entry from the digital artifact; and
stitching a following entry of the digital artifact to a preceding entry of the digital artifact to remove a gap created by cropping out of the at least one timeline entry; and
the method further comprises saving a filtered version of the digital artifact without the at least one timeline entry as a filtered digital artifact, in addition to an original unfiltered digital artifact.

13. The method of claim 11, wherein monitoring for the indicators of the strained relationship comprises training an artificial intelligence (AI) model with data models associated with normal relationship status and implicit and explicit indicators of strained relationship status, wherein the AI model enables performance of the monitoring of the user inputs and analyzes content within the communication exchanges and contexts associated with detected patterns in communication by the user.

14. The method of claim 13, further comprising:
continuing monitoring for indicators of relationship changes between the user and the at least one second person;
storing, in a repository, updated implicit relationship status indicators and updated explicit relationship status indicators identified during monitoring;
assessing via the AI model whether a current relationship status appears to no longer be strained;
generating and presenting on the output device a notification to prompt the user to affirm that the relationship status is no longer strained; and
in response to receiving user input indicating the relationship status is no longer strained, presenting an unfiltered version of the digital artifact that comprises timeline entries associated with the at least one second person during subsequent generation and presentation of new digital artifacts.

15. The method of claim 11, further comprising:
maintaining a current relationship status with the at least one second person within a corresponding entry of a repository; and
in response to the monitoring providing indication of the strained relationship status with the at least one second person, automatically updating the corresponding entry within the repository to include the strained relationship status in lieu of or in addition to a previous relationship status, the updating comprising providing a timestamp recording a time of detecting the strained relationship status.

16. The method of claim 15, further comprising:
prior to updating the repository:
generating and presenting a prompt to the user of the electronic device to confirm or deny the strained relationship status associated with the at least one second person; and
in response to receiving user confirmation of the strained relationship status:
updating the repository; and
initiating monitoring for retrieval of pre-generated digital artifacts comprising timeline entries associated with or invoking memories of the at least one second person in order to one of (i) suppress the digital artifact altogether or (ii) filter out the timeline entries from the digital artifact prior to presenting the digital artifact on the output device.

17. The method of claim 11, wherein:
the digital artifact comprises a timeline blog that comprises a plurality of sequentially presented timeline entries, with at least one timeline entry having an associated context that is associated with one or more second persons; and
the method further comprises:
detecting creation of the timeline blog as a new digital artifact comprising the at least one timeline entry associated with the at least one second person;
identifying a contemporaneous relationship status with the at least one second person at a time during an activity corresponding to the at least one timeline entry; and
in response to the relationship status indicating a current strained relationship, tagging the at least one timeline entry to indicate the strained relationship status.

18. A computer program product comprising a non-transitory computer readable medium having program instructions that when executed by a processor of an electronic device, configure the electronic device to perform functions comprising:
monitoring, within user inputs received at an electronic device and communication exchanges and communication patterns with one or more external sources, for indicators of a strained relationship between a user of the electronic device and at least one second person with whom the user has an association; and
in response to a trigger to retrieve and output a digital artifact via an output device of the electronic device:
identifying whether the digital artifact comprises at least one timeline entry that invokes thoughts of, or is associated with, at least one of (i) the at least one second person with whom the user currently has a strained relationship or (ii) at least one specific activity that is associated with the at least one second person with whom a strained relationship status is recorded contemporaneously with the specific activity and which is determined to presents an ongoing negative user association within the digital artifact; and in response to the digital artifact comprising the at least one timeline entry:
removing the at least one timeline entry from the digital artifact; and
presenting the digital artifact on the output device without the at least one timeline entry.

19. The computer program product of claim 18, wherein:
the program instructions for removing the at least one timeline entry comprises further comprises program instructions for:
cropping the at least one timeline entry from the digital artifact; and
stitching a following entry of the digital artifact to a preceding entry of the digital artifact to remove a gap created by cropping out of the at least one timeline entry; and
the program instructions further comprises program instructions for saving a filtered version of the digital artifact without the at least one timeline entry as a filtered digital artifact, in addition to an original unfiltered digital artifact.

20. The computer program product of claim 18, further comprises program instructions for:
continuing monitoring for indicators of relationship changes between the user and the at least one second person;
storing, in a repository, updated implicit relationship status indicators and updated explicit relationship status indicators identified during monitoring;
assessing via an AI model whether a current relationship status appears to no longer be strained;
generating and presenting on the output device a notification to prompt the user to affirm that the relationship status is no longer strained; and
in response to receiving user input indicating the relationship status is no longer strained, presenting an unfiltered version of the digital artifact that comprises timeline entries associated with the at least one second person during subsequent generation and presentation of new digital artifacts.
